(19) United States
(12) Patent Application Publication
(10) Pub. No.: US 2012/0046768 A1
(43) Pub. Date: Feb. 23, 2012

(54) METHOD FOR PROVIDING MULTIMEDIA DATA TO A USER

(75) Inventor: Matthew Raoufi, Lund (SE)

(73) Assignee: SONY ERICSSON MOBILE COMMUNICATIONS AB, Lund (SE)

(21) Appl. No.: 13/120,401

(22) PCT Filed: Aug. 19, 2010
(86) PCT No.: PCT/EP10/05091

§ 371 Date: Mar. 22, 2011

(51) Int. Cl. G06F 17/00

(52) U.S. Cl. 700/94

(57) ABSTRACT

The present invention relates to a method for providing multimedia data to a user (1). According to the method, multimedia data which is to be output to the user (1) is received, and a direction (42) in which the user's head (43) is directed is automatically determined. Based on the determined direction (42) in which the user's head (43) is directed, the multimedia data is adapted. The multimedia data may comprise audio data or visual data.

The present invention relates to a method for providing multimedia data to a user, and to a mobile device adapted to perform this method. In particular, the present invention relates to providing three-dimensional audio data or visual data to a user, wherein the three-dimensional audio data is output via a headset or an earspeaker to the user and the visual data is output to the user via a display mounted at the user, for example eyeglasses comprising an electronically controlled display.

### BACKGROUND OF THE INVENTION

Three-dimensional audio (3D audio) becomes more common in devices like stereos and home entertainment or car entertainment systems, and mobile devices, for example mobile phones, are going to follow this trend. 3D audio may comprise sound effects that attempt to create the illusion of sound sources placed anywhere in three-dimensional space, including behind, in front, left, right, above or below a listener. While the use of three-dimensional audio is of less concern in devices having stationary character, due to their mobility it is much harder to apply these techniques to mobile devices. When a mobile device is used with earpieces for reproducing audio data, for example a headphone or an earspeaker, which are attached to the head of the listener, the listener has no possibility to turn the head towards the sound to hear one source better than another source, whereas when using a stationary device with speakers spatial fixed the user has this possibility.

When a user of a mobile phone is for example attending a telephone conference, it may be advantageous to provide the user with a full 3D audio experience by arranging the attendees of the telephone conference virtually around the user. FIG. 1 shows such an arrangement of a user 1 communicating in a telephone conference with persons 2 and 3. Audio sources representing the persons 2 and 3 are therefore placed virtually in different positions around the user's head, in the example shown in FIG. 1 person 2 is arranged at the right hand side in front of the user 1 and person 3 is arranged on the left hand side in front of the user 1. However, when the user 1 wants to listen more carefully to one of the persons 2 or 3, the user 1 may turn the head into the direction of this person. However, when the user 1 is listening to the telephone conference via a headset or earspeakers attached to the user's head, the audio sources of the persons 2 and 3 will move together with the user's head as shown in FIG. 2 and thus the three-dimensional audio experience is deteriorated.

The same applies to visual data. When the user is attending to a video conference, video data of the participants may be provided to the user. Videos of the participants or persons 2,3 may be arranged in the same way as the audio data as shown in FIG. 1. The video data may be presented to the user 1 via eyeglasses with incorporated displays as they are for example used in virtual reality systems. When the user 1 is moving the head for concentrating on one of the persons 2,3, the image or video of this person is also moving together with the user's head as shown in FIG. 2 and thus also the visual experience is deteriorated.

Therefore, it is an object of the present invention to avoid a deterioration of a multimedia experience when the user is turning the head. The term multimedia as it is used in this context relates to either audio data, three dimensional audio data, image data, or video data or a combination of the aforementioned data.

### SUMMARY OF THE INVENTION

According to the present invention, this object is achieved by a method for providing multimedia data to a user as defined in claim 1 and a mobile device as defined in claim 11. The dependent claims define preferred and advantageous embodiments of the invention.

According to an aspect of the present invention, a method for providing multimedia data to a user is provided. According to the method, multimedia data which is to be output to the user is received, and a direction in which the user's head is directed is automatically determined. The multimedia data is adapted in response to the determined direction in which the head of the user is directed. The multimedia data may comprise audio data or visual data like image data or video data. The audio data may comprise a plurality of audio signals which are to be output as three-dimensional audio data to the user. Each audio signal may be associated with an audio source which is virtually arranged in a three-dimensional manner with respect to a position of the user. The audio data may be adapted in response to the determined direction such that a volume of an audio signal associated with an audio source arranged in the direction in which the head of the user is directed is raised. By determining the direction in which the user is looking and adapting the audio data correspondingly, an automatic adaptation of three-dimensional audio data can be accomplished which provides the user a full three-dimensional audio experience as if the user is moving in an environment with real audio sources arranged in a three-dimensional way. Thus, for example listening to attendees of a telephone conference becomes more convenient for the user. In the same way visual data may be adapted in response to the determined direction of the user's head. For example, depending on the direction in which the user's head is directed, a section of the visual data may be displayed centered to the user. Therefore, when the user is turning the head, the image section of the displayed visual data changes and details of the image can be moved into the viewing center of the user.

According to an embodiment, the virtual arrangement of the audio sources is reconfigurable by the user. For example, when the method is used in connection with a telephone conference, the user may place the attendees of the telephone conference in an appropriate arrangement, for example the user may place the virtual sound source of the most important attendee straight in the middle in front of the user, and less important attendees in areas left or right beside the user. This configuration may be accomplished by a corresponding application on a graphical user interface of the mobile device.

According to another embodiment, the method comprises furthermore that the audio data is output to the user via a headset or an earspeaker. When the user is receiving the three-dimensional audio data via a headset or an earspeaker, the loudspeakers in the headset or the earspeaker are moving together with the head of the user and thus, without adapting the audio data to the direction in which the user's head is directed, the user always would receive the same three-dimensional audio experience while turning the head. This does not match to the real life experience the user has and is therefore considered as uncommon and inconvenient. Therefore, by adapting the audio data to be output to the user via a headset or an earspeaker in response to the determined direction in which the user's head is directed, provides a convenient full three-dimensional audio data experience.

The visual data may be output or displayed to the user via eyeglasses having for example electronic displays for displaying the visual data. When the user is looking at the visual data via the eyeglasses, the displays of the eyeglasses are moving together with the head of the user and thus, without adapting the visual data to the direction in which the user's head is directed, the user always would see the same image or video while turning the head. This does not match to the real life experience the user has and is therefore considered as uncommon and inconvenient. Therefore, by adapting the visual data to be output to the user in response to the determined direction in which the user's head is directed, provides a convenient receiving of the visual data.

The direction in which the user's head is directed may be determined by a compass which is arranged in the headset or the earspeaker or the eyeglasses. Furthermore, the direction in which the user's head is directed may be determined based on an angle between the direction of the user's head and the direction of the user's body. The direction of the user's body may be determined by a compass arranged at the user's body. The compass may be incorporated in a microphone mounted at the user's body or may be comprised in a separate housing or the mobile device mounted at the user's body. As the user may be moving while listening to the three-dimensional audio data or watching images or videos, for example when the user is walking around in a city, driving in a vehicle or traveling in a train, determining the direction in which the user's head is directed alone is not sufficient, but it has to be determined in which the direction the user is looking with respect to a main direction of the user. The main direction of the user may be defined for example by the direction of the user's body. Therefore, by determining an angle between the direction of the user's head and the direction of the user's body, the multimedia data can be adapted appropriately with respect to the reference system of the user, which is determined by the body of the user and with respect to the direction in which the head is directed relative to this reference system. As the microphone is typically attached at the body of the user, for example at a shirt of the user, a direction of the user's body can be determined based on an arrangement of the microphone. By using a compass arranged in the headset or the earspeaker or the eyeglasses for determining the direction of the user's head and a further compass in the microphone for determining the direction of the user's body, the required directions can be reliably determined. Furthermore, electronic compasses can be easily integrated into a housing of the microphone or a housing of the headset or eyeglasses due to their small sizes. Furthermore, electronic compasses are available at low cost and therefore suitable to be integrated in consumer products.

According to another aspect of the present invention a mobile device is provided. The mobile device comprises a direction termination unit adapted to determine a direction in which a head of a user of the mobile device is directed, and a processing unit connected to the direction termination unit. The processing unit is adapted to receive multimedia data which is to be output to the user and to determine a direction in which the user's head is directed. Furthermore, the processing unit is adapted to adapt the multimedia data in response to the determined direction in which the user's head is directed. The mobile device may be adapted to perform anyone or a combination of the above-described methods and comprises therefore the above-described advantages. The direction termination unit may comprise two compasses, one compass integrated in a headset or an earspeaker or eyeglasses connected to the mobile device, and another compass integrated in a microphone connected to the mobile device.

The mobile device may comprise a mobile phone, a mobile navigation system, a personal digital assistant or a mobile music player.

Although specific features described in the above summary and the following detailed description are described in connection with specific embodiments, it is to be understood that the features of the embodiment can be combined with each other unless noted otherwise.

### BRIEF DESCRIPTION OF THE DRAWINGS

The invention will now be described in more detail with reference to the accompanying drawings.

FIG. 1 shows schematically a user receiving multimedia data.

FIG. 2 shows schematically the user of FIG. 1 after the user has turned the head, wherein the user receives multimedia data that has not been adapted according to the method of the present invention.

FIG. 3 shows schematically a mobile device according to an embodiment of the present invention.

FIG. 4 shows schematically a user receiving three-dimensional audio data adapted according to the method of the present invention.

FIG. 5 shows schematically a user receiving three-dimensional audio data from a plurality of audio sources.

FIG. 6 shows the user of FIG. 5 after the user has turned the head, wherein the user receives three-dimensional audio data which has been adapted according to the method of the present invention.

### DETAILED DESCRIPTION OF PREFERRED EMBODIMENTS

In the following, exemplary embodiments of the present invention will be described in more detail. It has to be understood that the following description is given only for the purpose of illustrating the principles of the invention and is not to be taken in a limiting sense. Rather, the scope of the invention is defined only be the appended claims and not intended to be limited by the exemplary embodiments hereinafter.

It is to be understood that the features of the various exemplary embodiments described herein may be combined with each other unless specifically noted otherwise. Same reference signs in the various instances of the drawings refer to similar or identical components.

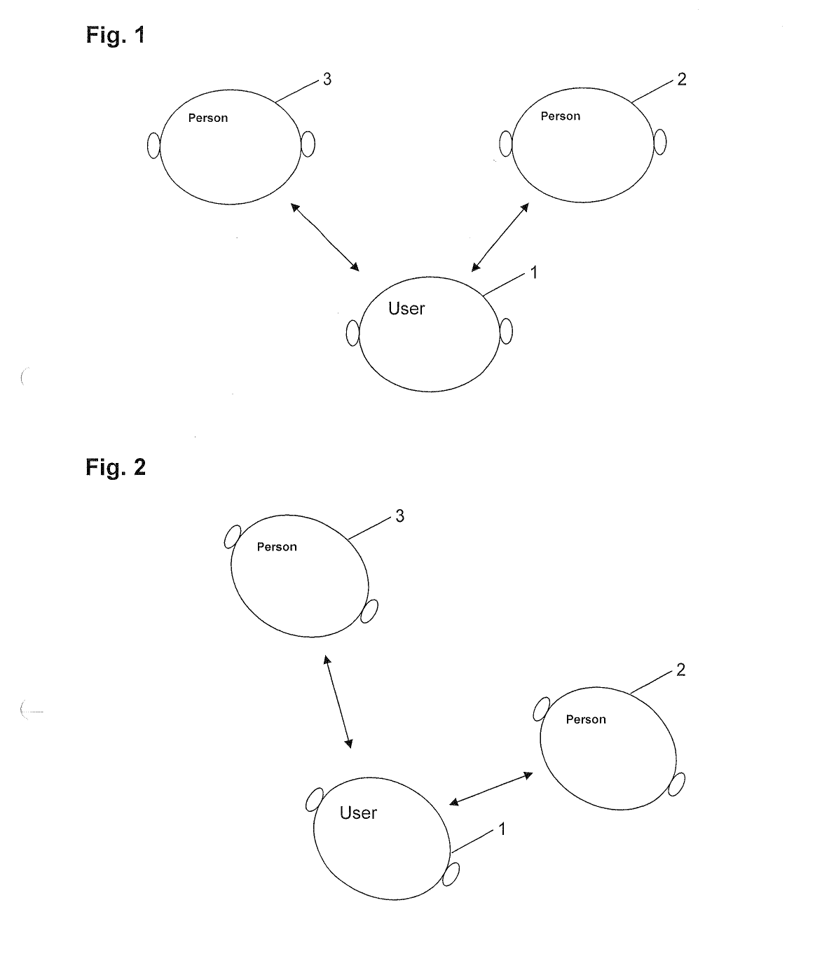

FIG. 1 shows a user 1 receiving multimedia data, for example three-dimensional audio data, from two persons 2, 3 which are arranged virtually in an environment of the user 1. The persons 2, 3 are not physically or in person arranged in the environment of user 1, but may be remotely connected to the user 1 via a telecommunication connection. User 1 may be wearing a headset or an earspeaker to receive the audio data, for example speech, originating from persons 2, 3. For simulating a situation similar to persons sitting in a conference room, the audio data from person 2 is virtually arranged such that it appears to the user 1 that person 2 is located at the right hand side in front of user 1. Similarly, audio data originated from person 3 is presented to the user 1 as if person 3 is located at the left hand side in front of user 1. Playing back audio data via a headset or earspeakers as described above for simulating three-dimensional audio data in order to provide the user 1 with a full three-dimensional audio experience is known in the art and will therefore not be described in detail. The three-dimensional audio data may be generated by persons coupled to the user via a telephone conference as described above, or may be generated by games or videos.

However, when the user 1 wants to listen more closely to one of the audio sources, for example to the speech originating from person 2, the user 1 intuitively moves the head in the direction of person 2. This situation is shown in FIG. 2, wherein the user 1 has turned the head slightly to the right. However, as the three-dimensional audio data is played back by the headset or earspeakers affixed to the user 1, the three-dimensional audio data will also turn to the right which means in the example of FIGS. 1 and 2 that the persons 2, 3 are also virtually moving to the right and thus the user 1 will receive the same three-dimensional audio data no matter in which direction the user's head is heading. Therefore, the user is not able to turn the head towards the direction of sound as in a real world. For improving the three-dimensional audio experience and making the experience more natural, according to the present invention a direction in which the user's head is directed is automatically determined. Based on the determined direction in which the user's head is directed, the three-dimensional audio data is automatically adapted. In stationary systems or as long as the user is not moving around as a whole, the direction in which the user's head is directed may be determined for example by a camera monitoring the user or by a compass affixed to the user's head. For mobile devices, for example mobile phones, a determination of the direction in which the user's head is directed is much more complicated as the user may walk around or may be moved when the user is located in a driving car or a driving train.

The multimedia data may also comprise visual data, for example image or video data, which is presented to the user by displays mounted in front of the eyes of the user, for example in form of eyeglasses as known from virtual reality systems. However, when the user 1 is turning the head, the displays of the eyeglasses will move together with the head. This is not the way visual data in front of the user behaves in real world. In real world the user can select an image section of the environment by moving or turning the head. Therefore, for visual data the same problem arises as for audio data mentioned above.

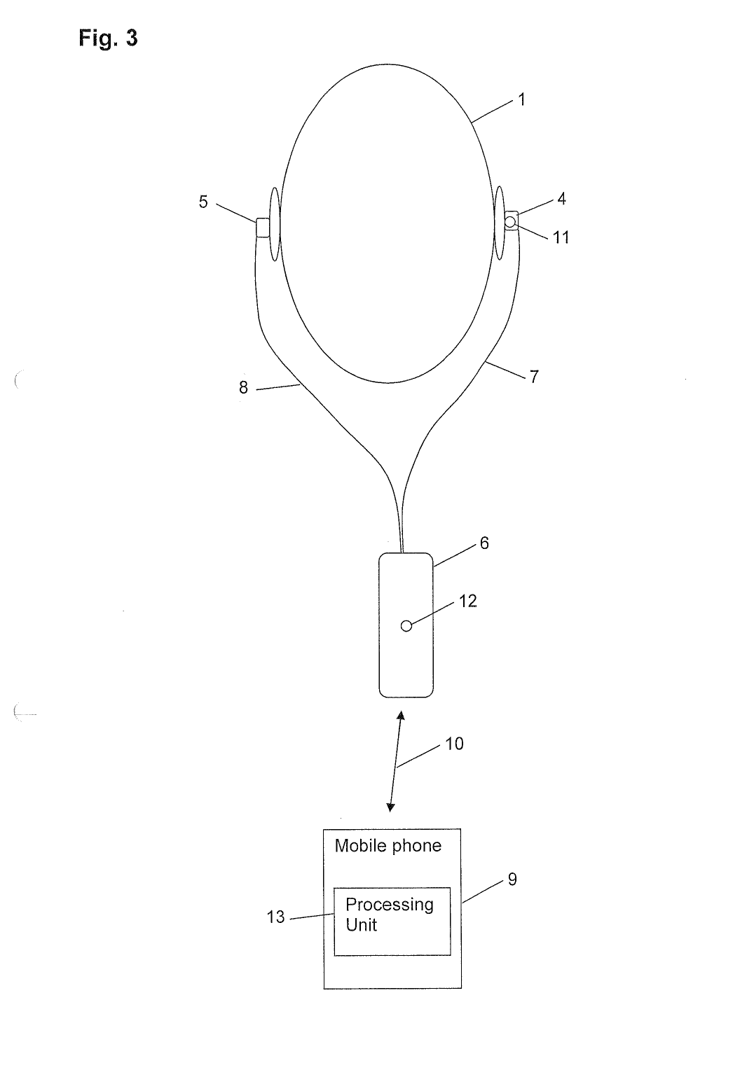

FIG. 3 shows a system according to the present invention solving the posed problem to determine the direction in which the user's head is directed for mobile devices. As shown in FIG. 3 the user 1 is wearing earspeakers 4 and 5. The earspeakers 4 and 5 are connected to a microphone 6 via connecting cables 7 and 8, respectively. The microphone 6 is coupled to the mobile phone 9, for example via a wired connection or via a wireless connection 10, for example a radio frequency connection like Bluetooth. The microphone 6 may be affixed to our mounted at the user's body with a clip (not shown). In the earspeaker 4 a first compass 11 is integrated. A second compass 12 is integrated in the microphone 6. The first and the second compasses 11, 12 may comprise any kind of compass adapted to determine a direction in which the compass is directed. For example, the compasses 11, 12 may comprise electronic compasses comprising Hall sensors for determining a direction in which the compass is directed in relation to the magnetic field of the earth. The compasses 11, 12 are coupled to a processing unit 13 of the mobile device 9 and, in operation, transmit signals representing a current direction of each of the compasses 11, 12. The processing unit 13 is adapted to evaluate the signals received from the compasses 11, 12 and to determine an angle or a change of an angle between the direction of the first compass 11 and the direction of the second compass 12. As the first compass 11 is mounted at the user's head and the second compass is mounted at the user's body, a change of the angle between the direction of the first compass and the direction of the second compass indicates that the user's head has turned and thus the three-dimensional audio data output by the mobile phone 9 can be adapted accordingly. In the same way visual data may be adapted according to the determined change of the angle between the direction of the first compass and the direction of the second compass. Furthermore, the first compass may be integrated in eyeglasses the user is wearing.

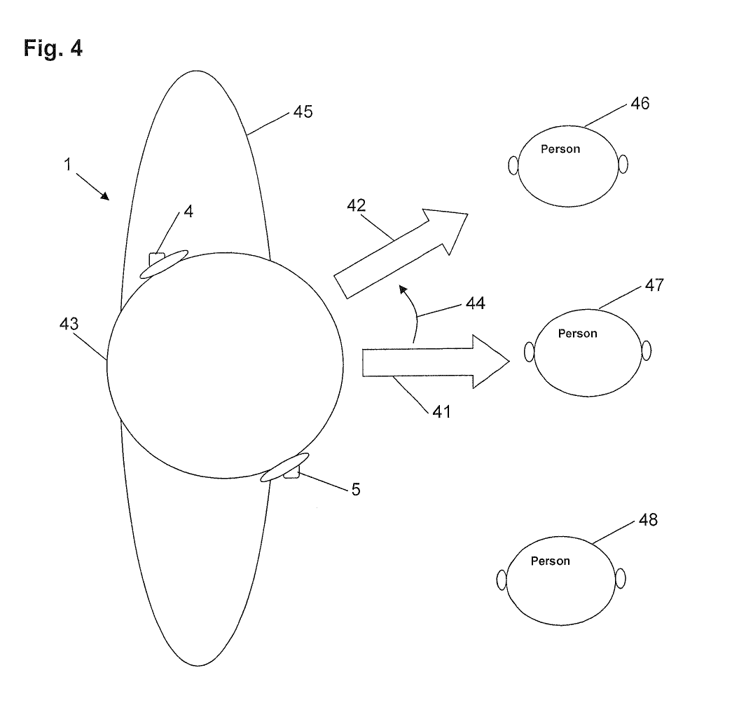

FIG. 4 shows a top view of user 1 wearing earspeakers 4, 5 of the system described in connection with FIG. 3. As can be seen from FIG. 4, the direction in which the user's head is directed is changing from direction 41 to direction 42 when the user turns the head 43 around an angle 44. Furthermore, as can be seen from FIG. 4, the body 45 of the user does not turn while the head 43 is turning. Therefore, when the user 1 turns the head 43, compass 11 in earspeaker 4 will indicate a change of direction whereas compass 12 in the microphone 6 will indicate no change of direction. From this information the processing unit 13 can determine the angle 44. When the user is traveling, for example sitting in a car or a train, the whole arrangement comprising the head 43, the body 45, the microphone 6, and the earspeakers 4, 5 may change direction due to a change of direction of the vehicle in which the user 1 is sitting. However, independently from this change of direction of the vehicle, a turning of the head 43 in relation to the body 45 can be reliably determined by evaluating the directions indicated by the compasses 11 and 12.

Assuming the user 1 is listening to a telephone conference in which beside the user 1 three more persons 46-48 are involved, the persons 46-48 may be virtually arranged in front of the user 1 such that person 46 is arranged in front of the user 1 on the left-hand side, person 47 is arranged straight in front of the user 1 and person 48 is arranged at the right-hand side in front of user 1. When the user 1 is directing the head 43 in direction 41, which means that the user is looking straight in the direction of person 47, audio data from person 46 are represented to the user 1 as being originated from the left-hand side in front of the user 1, audio data from person 47 is represented to the user as being originated from straight in front of the user 1, and audio data from person 48 are represented to the user 1 as being originated from the left-hand side in front of the user 1. Thus the user is provided with a three-dimensional audio experience as shown in FIG. 4. When the user 1 is turning the head to the left around angle 44, this is automatically determined by the processing unit 13 and the three-dimensional audio data will be re-arranged as described in the following. The user's head is now directed in direction 42, which means the user 1 is now looking straight at person 46. Therefore, audio data from person 46 are now represented to the user 1 as being originated straight in front of the user 1, audio data from person 47 are now represented to the user as being originated on the right-hand side in front of user 1, and audio data from person 48 are now represented to the user 1 as being originated right beside the user 1. Additionally, the volume of audio data from person 46 may be raised. Thus, the three-dimensional audio experience appears more natural to the user 1.

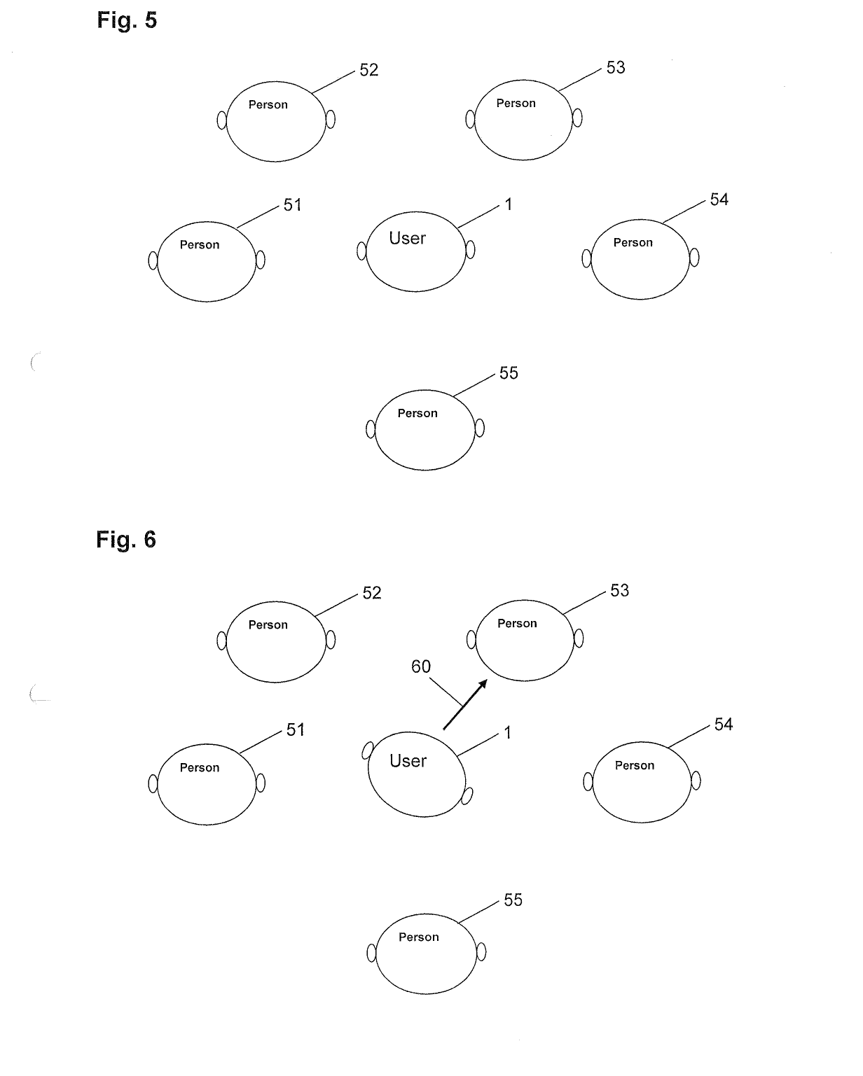

FIG. 5 shows another embodiment of the present invention. The user 1 in FIG. 5 is involved in a telephone conference with five other persons 51-55. With a configuration tool of the mobile device 9, for example via a graphical user interface of the mobile device 9, the user 1 is allowed to arrange the participants 51-55 of the telephone conference virtually around the user 1. The user 1 may for example arrange the persons such that the most important persons 52, 53 of the telephone conference are arranged in front of the user 1, further persons 51, 54 which are less important are arranged beside the user 1, and unimportant persons like person 55 are arranged behind the user 1. When the user 1 wants to listen more closely to one of the persons 51-55, the user just has to turn the head into the direction of this person and the three-dimensional audio reproduction will be adapted such that it appears to the user 1 that audio data from the assigned person is coming from the direction the user is looking at. FIG. 6 shows an example where the user has turned the head into the direction of person 53 as indicated by arrow 60. After having determined the direction the user 1 is looking at by comparing the direction of the compass 12 mounted at the user's body and the direction of the compass 11 mounted at the user's head, the three-dimensional audio data is adapted such that audio data from person 53 appears to be originated in the direction the head of the user 1 is now directed. As the turning of the head of the user 1 is determined in relation to the direction of the body of the user 1, the three-dimensional audio data can be reproduced naturally as expected by the user 1 even if the user is moving, for example walking around or traveling in a vehicle.

While exemplary embodiments have been described above, various modifications may be implemented in other embodiments. The method may be used in connection with mobile devices as well as in connection with stationary devices. Furthermore, the orientation of the user's head may be determined by any other means, for example by a video camera or by acceleration sensors. Moreover, although in the embodiments described above, the multimedia data which has to be provided to the user was generated by participants of a telephone conference, the multimedia data may be generated by any other kind of multimedia source, for example by a gaming application performed on the mobile device or a video being played back by the mobile device. Additionally, the earspeakers can be coupled to the mobile device via a wireless connection and the compass attached at the body can be coupled to the mobile device also via a wireless connection. Thus, no wires or cables are necessary for coupling the compasses to the mobile device.

Finally, it is to be understood that all the embodiments described above are considered to be comprised by the present invention as it is defined by the appended claims.

1-13. (canceled)

14. A method for providing multimedia data to a user, the method comprising the steps of:
receiving multimedia data to be output to the user,
automatically determining a direction in which the user's head is directed, and
adapting the multimedia data in response to the determined direction in which the user's head is directed.

15. The method according to claim 14, wherein the multimedia data comprises audio data.

16. The method according to claim 15, wherein the audio data comprises a plurality of audio signals to be output as three dimensional audio data, each audio signal being associated with one of a plurality of audio sources being virtually arranged in a three dimensional manner with respect to a position of the user, wherein adapting the audio data in response to the determined direction comprises raising a volume of an audio signal associated with the audio source arranged in the direction in which the user's head is directed.

17. The method according to claim 16, wherein the virtual arrangement of the audio sources is reconfigurable by the user.

18. The method according to claim 15, further comprising outputting the audio data to the user via a headset or an ear speaker.

19. The method according to claim 14, wherein the multimedia data comprises visual data.

20. The method according to claim 19, further comprising outputting the visual data to the user via eyeglasses comprising displays adapted to display the visual data.

21. The method according to claim 18, wherein the direction in which the user's head is directed is determined by a compass device coupled to the headset or the ear speaker.

22. The method according to claim 20, wherein the direction in which the user's head is directed is determined by a compass device coupled to the eyeglasses.

23. The method according to claim 14, wherein the direction in which the user's head is directed is determined based on an angle between the direction of the user's head and a direction of the user's body.

24. The method according to claim 22, wherein the direction of the user's body is determined by a compass device coupled to a microphone mounted at the user's body.

25. A mobile device, comprising
a direction determination unit adapted to determine a direction in which a head of a user of the mobile device is directed, and
a processing unit connected to the direction determination unit,
wherein the processing unit is adapted to receive multimedia data to be output to the user, determine a direction in which the user's head is directed, and adapt the multimedia data in response to the determined direction in which the user's head is directed.

26. The mobile device according to claim 25, wherein the mobile device is adapted to perform a method comprising the steps of: receiving multimedia data to be output to the user; automatically determining a direction in which the user's head is directed, and adapting the multimedia data in response to the determined direction in which the user's head is directed.

27. The mobile device according to claim 25, wherein the mobile device comprises a mobile device selected from the group comprising a mobile phone, a mobile navigation system, a personal digital assistant and a mobile music player.
